(19) United States
(12) Patent Application Publication
(10) Pub. No.: US 2016/0231591 A1
(43) Pub. Date: Aug. 11, 2016

(54) EYEWEAR HAVING COMPRESSION HINGES

(71) Applicant: Brent Sheldon, Miami Beach, FL (US)

(72) Inventors: Brent Sheldon, Miami Beach, FL (US); Patrick Mainville, Montreal (CA); Melody Sue Myette, Montreal (CA); Thomas Rouayroux, Montreal (CA); Antoine Dallaire, Montreal (CA); Richard Pare, Boucherville (CA)

(21) Appl. No.: 14/619,726

(22) Filed: Feb. 11, 2015

(51) Int. Cl. G02C 5/22

(52) U.S. Cl. CPC G02C 5/2254

(57) ABSTRACT

Eyewear includes a compression-hinge apparatus having first and second hinge elements pivotally joined together to connect respective side pieces to a central part of the eyewear. The compression-hinge apparatus includes a compressible foam body received in a cavity defined in the central part or in a corresponding one of the side pieces. The first hinge element abuts the compressible foam body and is displaceable with respect to the central part or the corresponding side piece which defines the cavity, thereby allowing an over flexed position of the side piece with respect to the central part.

### TECHNICAL FIELD

The application relates generally to eyewear and more particularly to eyewear having a pair of temples joined to a frame structure of the eyewear by respective compression hinges.

### BACKGROUND OF THE ART

Spring hinges used in eyewear are known. They serve to connect the lens-containing central part of eyewear to the side pieces in a flexibly resilient manner. The side pieces can be displaced from a folded position in which they abut against the central part, to an unfolded position in which they are pivoted outward to extend at approximately right angles to the central part. If the side pieces are pivoted outward beyond the unfolded position, a spring device in the spring hinge is activated to allow the side pieces to over flex without breakage and to draw the side pieces back into the unfolded position. The spring hinges including the spring device are conventionally made of metal material and are conventionally configured for use in a metal frame structure of eyewear. However, these conventional spring hinges may not meet users' needs for over flexing of modern eyewear styles.

Accordingly, there is a need for eyewear having improved types of “over flexed” hinge apparatus.

### SUMMARY

In one aspect, there is provided eyewear comprising a central part including at least one lens, a pair of side pieces, and a pair of compression hinges each pivotally connecting a corresponding one of the side pieces to the central part, each compression hinge comprising a first hinge element and a second hinge element pivotally joined one with the other, and a compressible foam body accommodated in a cavity defined in one of the central part and the corresponding side piece, the first hinge element abutting the compressible foam body and being displaceable with respect to said one of the central part and the corresponding side piece which defines the cavity.

Optionally, the cavity may be located in a rigid plastic part of said one of the central part and the corresponding side piece of the eyewear.

### DESCRIPTION OF THE DRAWINGS

Reference is now made to the accompanying figures in which:

FIG. 1 is a perspective view of a pair of eyeglasses having a pair of compression-hinge apparatuses according to one embodiment;

FIG. 2 is an enlarged partial top view of the circled area A of the eyeglasses of FIG. 1, showing the compression-hinge apparatus according to one embodiment;

FIG. 3 is a cross sectional view of the compression-hinge apparatus taken along line 3-3 of FIG. 2;

FIG. 4 is a partial cross-sectional view of the compression-hinge apparatus taken along line 4-4 of FIG. 3;

FIG. 5 is a partial perspective view of the compression-hinge apparatus of FIG. 2, showing a cavity defined in a plastic part positioned in one end of a side piece of the eyeglasses;

FIG. 6 is an enlarged perspective view of the circled area A of the eyeglasses of FIG. 1, showing the compression-hinge apparatus according to another embodiment;

FIG. 7 is an exploded perspective view of the compression-hinge apparatus of FIG. 6; and

FIG. 8 is a partial perspective view of the compression-hinge apparatus of FIG. 6 showing a cross section thereof taken along line 8-8 in FIG. 6.

It will be noted that throughout the appended drawings, like features are identified by like reference numerals.

### DETAILED DESCRIPTION

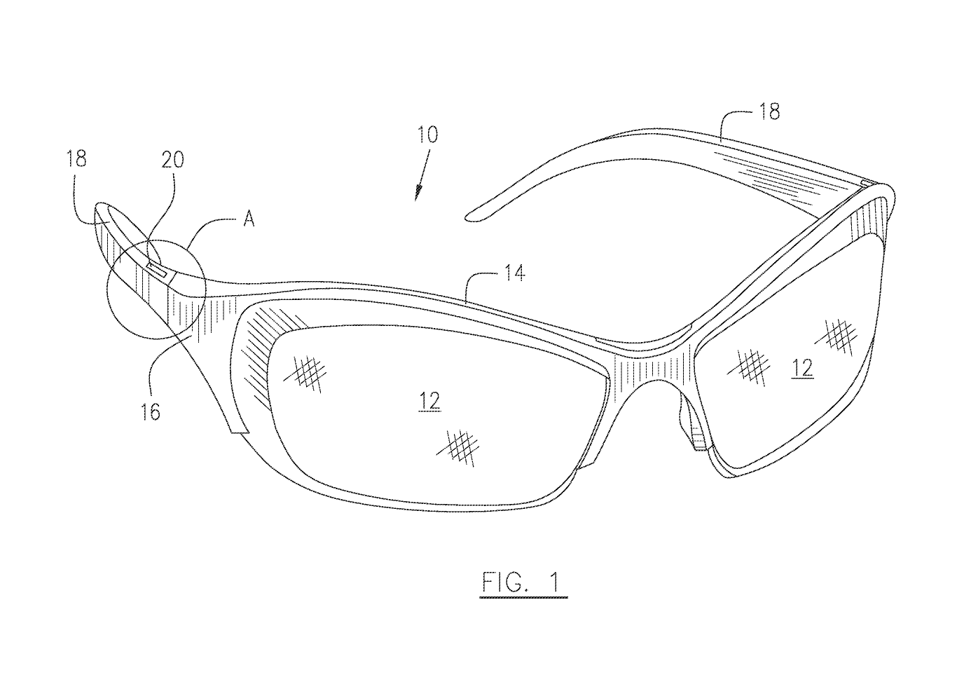

FIG. 1 illustrates an eyewear having a central part holding at least one lens and pivotally connecting two side pieces thereto. For example, eyeglasses 10 include a pair of lenses 12 attached to a central part 14 of the eyeglasses 10 which may be made in a rigid frame structure having opposed side ends (not numbered) forming respective end bases 16. A pair of side pieces 18 such as temples each are pivotally connected to the respective end bases 16 of the central part 14, by a compression-hinge apparatus 20. Due to the symmetrical configuration of eyeglasses 10, only one compression-hinge apparatus 20 which pivotally connects a corresponding one of the side pieces 18 to an end base 16, is described and illustrated hereinafter.

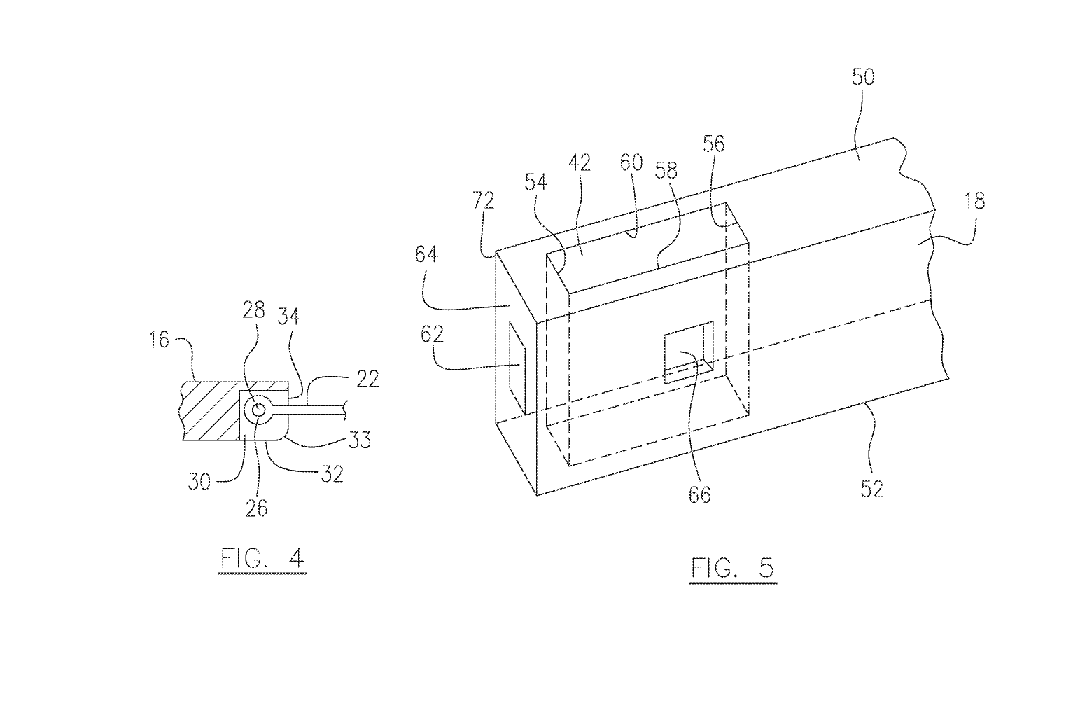

Referring to FIGS. 1-5, the compression-hinge apparatus 20 according to one embodiment, may include a connector 22 (a first hinge element) having opposed ends (not numbered). The connector 22 at one end thereof may have an abutment member 24 and at the other end thereof, may define a hole 26 (see FIG. 4) extending therethrough in a substantially vertical direction. The compression-hinge apparatus 20 may include a pin 28 (a second hinge element) rotatably extending through the hole 26. The pin 28 may extend substantially vertically through a recess 30 defined in the end section 16 of the central part 14 (see FIGS. 3 and 4). Top and bottom sections (not numbered) of the pin 28 may be embedded in and secured by the end base 16 (see FIG. 3). The recess 30 may have openings (not numbered) defined in both an inner facing surface 32 and a rear facing surface 34 thereof to accommodate an end section (not numbered) of the connector 22 and to permit the connector 22 to rotate about the pin 28 between positions corresponding to the respective folded and over flexed positions of the side piece 18, as indicated by broken lines 36 and 38, respectively.

The compression-hinge apparatus 20 may further include a compressible foam body 40 accommodated in a cavity 42 defined in for example the side piece 18. The side piece 18 may be formed as a rigid plastic single piece or may be formed of composite materials such as plastic and metal materials in which the cavity 42 may be defined in a rigid plastic end section of the side piece 18.

The compressible foam body 40 may be made of an elastically-deformable foam material which can be compressed under external forces and can return to its original shape when the external forces are removed. The compressible foam body 40 according to one embodiment may be in a block profile defining a vertical passage 44 for receiving the abutment member 24 to be inserted thereinto, and a horizontal passage 46 for receiving the connector 22 to be inserted thereinto. The connector 22 and the abutment member 24 may be connected together with the compressible foam body 40, for example by a screw 48 extending laterally through the compressible foam body 40, the connector 22 and the abutment member 24.

The cavity 42 defined in the rigid plastic end section of the side piece 18 may be configured to have a rectangular cross section (corresponding to the block profile of the compressible foam body 40) extending through the rigid plastic end section of the side piece 18 to define a rectangular opening (not numbered) on one or both of top and bottom surfaces 50, 52 of the side piece 18. The compressible foam body 40 may therefore be inserted into the cavity 42 through the top opening or bottom opening of the cavity 42.

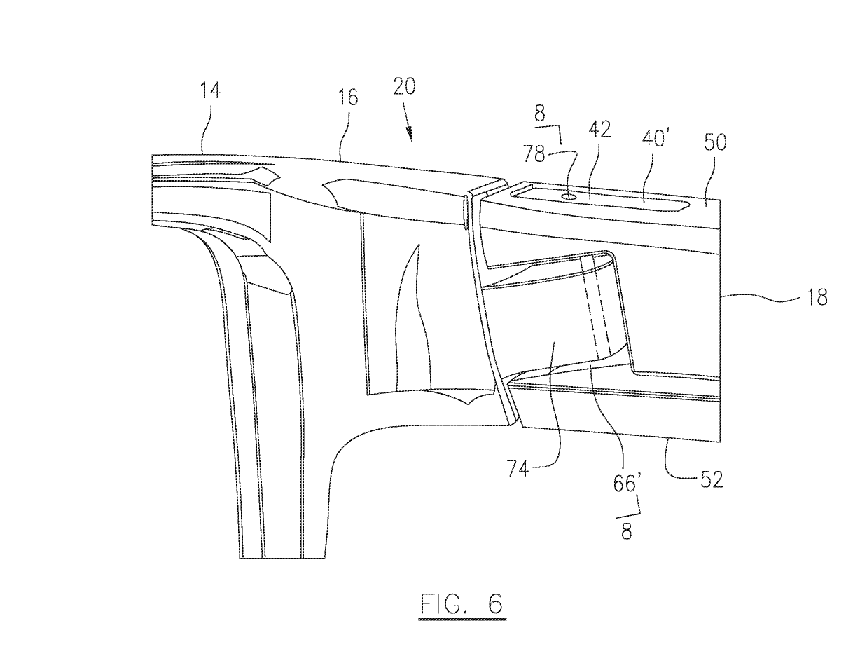

The cavity 42 defined in the rigid plastic end section of the sides piece 18 is thus surrounded by opposed end walls 54, 56 and by opposed inner and outer side walls 58, 60 (see FIG. 5). An end opening 62 may be defined on an end surface 64 of the side piece 18 and may extend through the end wall 54 of the cavity 42 to permit the connector 22 to extend therethrough. Therefore, the connector 22 at one end thereof may be pivotally joined with the pin 28 (which is attached to the end base 16 of the central part 14) and at the other end thereof may be connected to the compressible foam body 40 which is accommodated in the cavity 42 in the side piece 18, thus pivotally connecting the side piece 18 to the central part 14.

The cavity 42 according to one embodiment. may further define a side opening 66 at an inner side and/or outer side of the side piece 18. The side opening 66 may extend through the inner side wall of the cavity 42 and/or may extend through the outer side wall 60 of the cavity 42. The side opening 66 permits the screw 48 to be placed into the cavity 42 to join the connector 22 and the abutment member 24 with the compressible foam body 40. Nevertheless, the connector 22 and the abutment member 24 may be otherwise configured and otherwise joined together such that the side opening 66 may not be required.

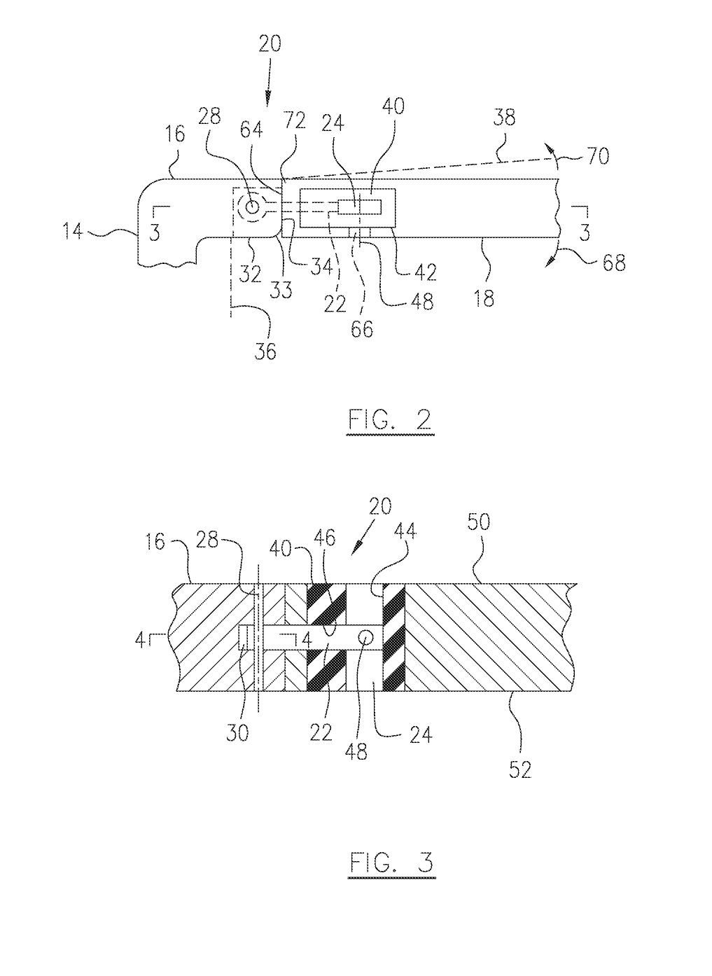

Referring to FIG. 2, the end base 16 of the central part 14 may be provided with a rounded corner 33 between the inner facing surface 32 and the rear facing surface 34. The inner facing and rear facing surfaces 32, 34 connected by the rounded corner 33 thereby form a cam surface in contact with the end surface 64 when the side piece 18 is in pivotal motion (such as indicated by arrow 68) about the pin 28 between the unfolded position and the folded position indicated by the broken line 36, as shown in FIG. 2. The compressible foam body 40 is in a relatively uncompressed condition when the side piece 18 is in the folded or unfolded position and will be compressed by the abutment member 24 (see FIG. 3) when the side piece 18 is pivoted from one to the other position because the cam action will force the end surface 64 of the side piece 18 (see FIG. 5) to deviate away from the pin 28 to thereby cause displacement between the abutment member 24 together with the connector 22 and the side piece 18. A recovery force of the compressed foam body 40 has a tendency to bring the side piece 18 back to the unfolded or to the folded position.

When a force 70 is applied to the side piece 18 in order to pivot the side piece 18 outward, past the unfolded position, a corner 72 between the end surface 64 and the outer side of the side piece (see FIGS. 2 and 5) will act as a stopper against the pivoting motion of the side piece 18 about the pin 28. However, when such external force 70 continues, the side piece 18 pivots about the corner 72 beyond the unfolded position to an over flexed position, as indicated by the broken line 38, which causes the end surface 64 of the side piece 18 to deviate away from the pin 28, resulting in displacement of the connector 22 and the abutment member 24 with respect to the side piece 18. Therefore, the compressible foam body 40 is compressed by the abutment member 24 when the side piece 18 is forced to the over flexed position indicated by broken line 38. When the external force 70 is removed, the recovery force of the compressed foam body 40 has a tendency to bring the side piece 18 back to the unfolded position.

It should be noted that the compression-hinge apparatus 20 may be alternatively arranged. For example, the pin 28 may be attached to the side piece 18 and the cavity 42 may be defined in the central part 14. In such an embodiment, other features of the compression-hinge apparatus 20 will be similar but arranged in accordance with the alternatively positioned pin, the compressible foam body and the cavity.

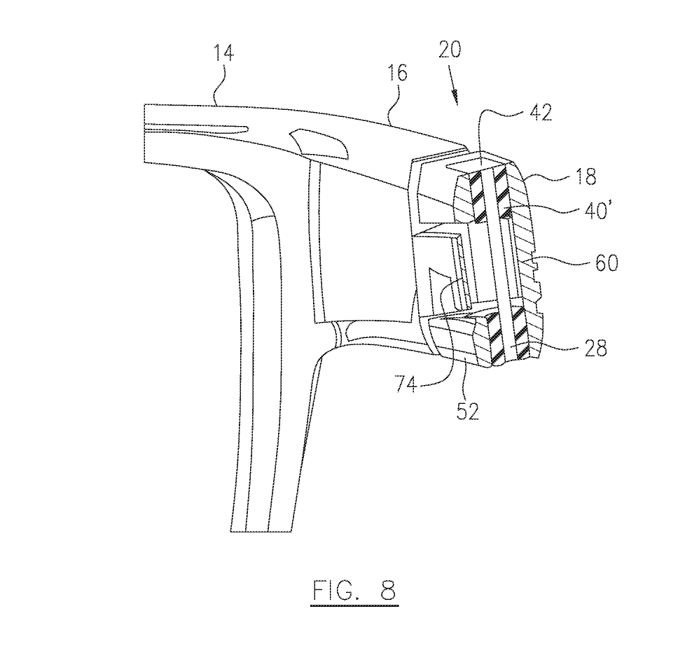

Referring to FIGS. 1 and 6-8, the compression-hinge apparatus 20 according to another embodiment may be configured to have the pin 28 (a first hinge element) to abut and compress a compressible foam body 40′ accommodated in the cavity 42 defined in the side piece 18 during a pivoting motion of the side piece 18 with respect to the central part 14. In comparison with the embodiment described with reference to FIGS. 1-5, similar features and structures indicated by similar reference numerals will not be redundantly described in detail

The cavity 42 defined in a rigid plastic end section of the side piece 18, similar to that shown in FIG. 5, may have a rectangular cross section extending vertically through the side piece 18 and may have the openings in the top and bottom surfaces 50, 52 thereof, formed with opposed end walls 54, 56 and opposed inner and outer side walls 58, 60. However, an end opening 62′ and an inner side opening 66′ extending through the respective end wall 54 and inner side wall 58 may be in communication one with the other without a wall corner structure therebetween.

A ring 74 (a second hinge element) may be attached to the rear facing surface 34 of the end base 16 of the central part 14, defining a hole 26′ therein to receive the pin 28 to extend therethrough. Optionally, the hole 26′ may be larger than the diameter of the pin 28. The ring 74 and the openings 62′ and 66′ of the cavity 42 may be configured and positioned to allow the ring 74 to be receivable and partially receivable in the cavity 42 through the end opening 62′ and the inner side opening 66′ allowing angular mobility between the two positions.

The compressible foam body 40′ according to one embodiment may have a block profile having a rectangular cross section corresponding to that of the cavity 42. The compressible foam body 40′ may have a recess 76 (see FIG. 7) at a middle portion thereof extending into the compressible foam body 40′ from one end which abuts the end wall 54 of the cavity 42 when the compressible foam body 40′ is accommodated in the cavity 42. The recess 76 may have openings at both sides of the compressible foam body 40′ and may be configured and positioned with respect to the openings 62′, 66′ of the cavity 42 in order to accommodate the ring 74, thereby allowing the above-described angular mobility of the ring 74 with respect to the side piece 18.

The side piece 18 may be pivotally joined to the central part 14 by the pin 28 extending through the hole 26′ of the ring 74 which is received or partially received in the recess 76 of the compressible foam body 40′. The opposed end portions (not numbered) of the pin 28 may be embedded in the compressible foam body 40′ such as being received in holes 78 defined in the compressible foam body 40′ which is accommodated in the cavity 42 in the side piece 18.

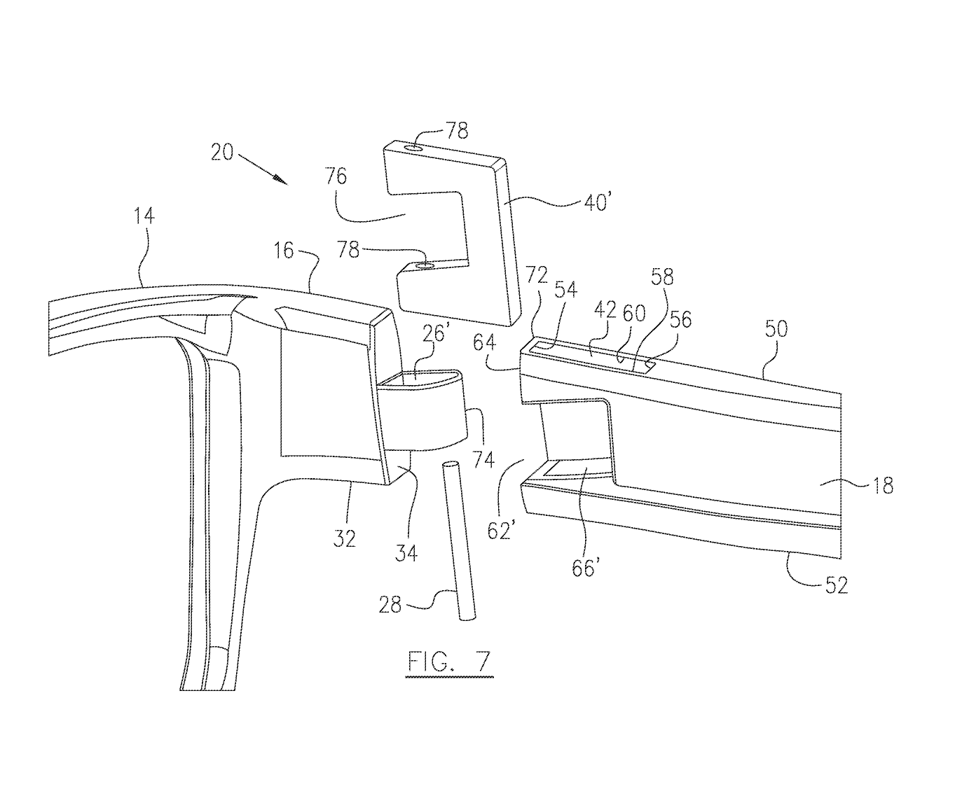

When an external force (not illustrated) is applied to the side piece 18 to pivot the side piece 18 from the unfolded position as shown in FIG. 6, outwardly or inwardly with respect to the central part 14, the rear facing surface 34 of the end base 16 and the end surface 64 of the side piece 18 interact such that the pin 28 is forced by the wall of the hole 26′ (the inner wall of the ring 74) to abut and compress the compressible foam body 40′ and the pin 28 is thereby displaced in the cavity 42 with respect to the side piece 18. The recovery force of the compressible foam body 40′ has a tendency to bring the side piece 18 back to the unfolded position (or to the folded position), similar as shown by broken line 36 in FIG. 2. Because there is no corner wall between the end opening 62′ and the inner side opening 66′ of the cavity 42, the angular mobility of the ring 74 received in the recess 76 of the compressible foam body 40′ and the cavity 42, allows the side piece 18 to pivot between the folded position and the unfolded position.

However, there are no openings defined in the outer side piece 18 corresponding with the side openings 66′ of the cavity 42. Therefore, the middle portion of the outer side wall 60 of the cavity located adjacent the end opening 62′ will interact with the ring 74 to prevent the side piece 52 from further outward angular motion with respect to the central part 14 when the side piece reaches a limited over flexed position such as indicated by the broken line 38 in FIG. 2.

It should be noted that the features of the compression-hinge apparatus according to this embodiment associated with the respective central part and the side piece may also be alternatively arranged. For example, the ring may be attached to the end surface of the side piece while the compressible foam body may be accommodated in a cavity in the central part.

The above description is meant to be exemplary only, and one skilled in the art will recognize that changes may be made to the embodiments described without departing from the scope of the described subject matter. Modifications which fall within the scope of the described subject matter will be apparent to those skilled in the art, in light of a review of this disclosure, and such modifications are intended to fall within the appended claims.

1. Eyewear comprising a central part including at least one lens, a pair of side pieces, and a pair of compression hinges each pivotally connecting a corresponding one of the side pieces to the central part, each compression hinge comprising a first hinge element and a second hinge element pivotally joined one with the other, and a compressible foam body accommodated in a cavity defined in one of the central part and the corresponding side piece, the first hinge element abutting the compressible foam body and being displaceable with respect to said one of the central part and the corresponding side piece which defines the cavity.

2. The eyewear as defined in claim 1 wherein the cavity is located in a rigid plastic part of said one of the central part and the corresponding side piece.

3. The eyewear as defined in claim 2 wherein the cavity defines an end opening extending through an end wall of the cavity, the first hinge element extending through the end opening.

4. The eyewear as defined in claim 2 wherein the cavity defines at least one of a top opening and a bottom opening.

5. The eyewear as defined in claim 2 wherein the cavity is located in a rigid plastic end section of the corresponding side piece.

6. The eyewear as defined in claim 5 wherein the cavity defines a side opening in one of inner and outer sides of the corresponding side piece.

7. The eyewear as defined in claim 5 wherein the first hinge element comprises a connector having opposed ends, the connector at one end thereof having an abutment member abutting the compressible foam body and the connector at the other end thereof defining a hole extending therethrough, and wherein the second hinge element comprises a pin attached to the central part and rotatably extending through the hole in the connector.

8. The eyewear as defined in claim 5 wherein the first hinge element comprises a pin and the second hinge element defines a hole, the pin of the first hinge element rotatably extending through the hole in the second hinge element.

9. The eyewear as defined in claim 8 wherein the pin of the first hinge element comprises opposed end portions embedded in the compressible foam body.

10. The eyewear as defined in claim 8 wherein the second hinge element comprises a ring attached to the central part and defining said hole in the second hinge element, extending through the ring.

11. The eyewear as defined in claim 10 wherein the hole defined in the ring is larger than a diameter of the pin of the second hinge element.

12. The eyewear as defined in claim 10 wherein the pin of the first hinge element extends through a recess of the compressible foam body with opposed end portions of the pin embedded in the compressible foam body, the recess of the compressible foam body accommodating the ring of the second hinge element to permit the ring to be angularly moveable with respect to the compressible form body.

13. The eyewear as defined in claim 12 wherein the cavity defines a side opening at an inner side of the side piece and defines an end opening extending through an end wall of the cavity, the side and end openings being in communication one with the other and being configured and positioned with respect to the recess of the compressible foam body in the cavity to permit said angular mobility of the ring.
